(19) United States
(12) Patent Application Publication
(10) Pub. No.: US 2009/0071869 A1
(43) Pub. Date: Mar. 19, 2009

(54) DISPLAY FOR SHEET GOODS AND METHOD OF ASSEMBLY

(76) Inventors: Edward S. Robbins, III, Muscle Shoals, AL (US); Josef A. Boukal, Madison, AL (US); Bryan F. Magee, Muscle Shoals, AL (US)

Correspondence Address: INDIANAPOLIS OFFICE 27879;BRINKS HOFER GILSON & LIONE, ONE INDIANA SQUARE, SUITE 1600, INDIANAPOLIS, IN, 46204-2033, US

(21) Appl. No.: 12/274,916

(22) Filed: Nov. 20, 2008

Related U.S. Application Data
(63) Continuation-in-part of application No. 11/842,258, filed on Aug. 21, 2007.
(60) Provisional application No. 60/841,426, filed on Aug. 31, 2006.

(51) Int. Cl. B65D 5/50; B23P 11/00

(52) U.S. Cl. 206/756; 29/428

(57) ABSTRACT

A display having two upstanding side panels hinged to opposite vertical edges of an upstanding front panel, the side panels having inwardly folded rear edges. A foot member coupled to lower corners of the junctions of the front panel with the side panels fix the position of the side panels relative to the front panel. Tabs located along the edges of a shelf are inserted into slots located in the front panel and the side panels to fix the position of the shelf. The slots are defined by a pair of horizontal slits cut in the upstanding panels to define a band of material between the pair of slits, the band of material being displaced inwardly to form a slot for receiving a corresponding tab. A foot member can be coupled to each of the lower corners defined by the junctions of a back panel with the side panels to fix the position of the back panel relative to the side panels. Caster assemblies on downward facing surfaces of the foot members facilitate movement of the display. Graphics panels can be secured to an outside surface of any or the upstanding panels with suitable indicia related to the product to be displayed.

### CROSS-REFERENCE TO RELATED APPLICATIONS

The present application is a continuation-in-part of Ser. No. 11/842,258 filed Aug. 21, 2007 which is in turn related to, and claims all available benefits from, U.S. Provisional Application Ser. No. 60/841,426 filed Aug. 31, 2006.

### BACKGROUND OF THE INVENTION

The present invention is directed to a display unit for various products and, specifically, to display sheet goods such as desk mats, floor mats, carpet mats and chair mats used to protect an underlying surface. In particular, the present invention relates to a display system having features that enhance the ease of displaying and handling, and improve the marketability of such sheet goods.

Display units are used to display and support products in various locations, such as a retail store, an office store, a convention, a club store or a mass merchandiser. Some display units are also used as shipping containers for products, especially when these products are small in size, such as U.S. Pat. No. 4,350,281 and U.S. Pat. No. 6,435,351. U.S. Pat. No. 4,350,281 discloses a one-piece shipping container/display unit for shipment, handling and display of articles as shown in FIGS. 7 and 8. The shipping container/display unit is constructed of a corrugated container formed from a unitary blank. The shipping container/display unit includes a pair of side and end walls integrally connected to form a bottom closure flap and top closure flap. As shown in FIG. 2 of U.S. Pat. No. 4,350,281, the side walls have an integrally connected side wall liner flap that functions as double wall construction. In addition, the bottom closure is constructed of bottom closure flaps to function as double wall construction. Double wall construction may be wasteful and unnecessary, especially when a display unit is not shipped as an assembled unit and is supported by other means when assembled.

Each bottom closure flap of shipping container/display unit forms a relatively short partial end wall liner suited to provide a minimum end wall remainder as shown in FIGS. 7, 8, 12 and 14 of U.S. Pat. No. 4,350,281. The end wall, however, compels the user to lift the article before removing the article from the shipping container/display unit. This can be very cumbersome, especially when only a few articles remain within shipping container/display unit, or when the product is shaped awkwardly. Furthermore, the shipping container/display unit must be used with other containers or another structure to provide the articles at a suitable elevation. An elevation is suitable when, while a user is removing the article from the shipping container/display unit, the user avoids much bending at the waist or of the back.

Additionally, when products are larger in size, the products are typically shipped separately from the display units. When shipped separately, the display units, then, are assembled at the destination where the products will be sold. To illustrate, FIG. 1 of U.S. Pat. No. 7,000,773 discloses such product display and support carton. The product display and support carton includes a display box and an opposed pair of dividers that define at least two separate product receiving compartments. The display box comprises of a bottom panel and an upwardly extending wall panel, which together form a product carrying enclosure. The product carrying enclosure is further divided by dividers that define at least two separate product receiving compartments. In addition, the display box has an open top defined by a top wall panel edge disposed opposite the bottom panel, and the product carrying enclosure is inclined at an angle to the vertical when the bottom panel is on a horizontal surface. The upwardly extending wall panel is preferably defined by an upwardly and rearwardly inclined front wall, an upwardly and rearwardly inclined rear wall, and a pair of generally parallel side walls. The front wall comprises of a product restraining wall. However, the front wall forces the article to be lifted before being removed from the shipping container/display unit. Moreover, the product carrying enclosure does not provide products at a suitable elevation.

When display units support larger products, the display units often need reinforcement or extra support. The extra support also typically raises the product above ground level in order for displayed products to be easily removed. U.S. Pat. No. 4,193,652 discloses in FIGS. 8 and 9 such a display case that incorporates a pedestal. The display case provides an upwardly open, transversally partitioned box preferably made of exteriorly decorated corrugated paper box board. The box has upper and lower edges which are protected and reinforced with square hoop-like metal frames. Dividers are hung from the metal frames. The display case may be free-standing or pedestal-supported, e.g., upon a similar case turned on its side or upon a vertical axis cruciform support. Samples of carpet are stowed in the individual upwardly open cells defined between the box sides and partitions are individually accessible. While the pedestal may provide the products at a suitable elevation, walls of the box do not allow the product to easily slide away when the product is removed horizontally from the container, and do not allow accessibility to the products from the side of the display case.

In my pending U.S. application published Mar. 6, 2008 as Publication No. 2008/0053867 I disclose a display unit that includes a rectangular body, a shelf, and a header. The rectangular body can include a back panel, a face panel, and two upstanding side panels having a top edge. The top edge of the side panels can be inclined to face frontward toward the face panel. The shelf can partition the rectangular body into an upper display area and a lower enclosure. Furthermore, the header can extend upwardly from the back panel. The face panel has a top edge that can be lower than the elevation of the shelf. In addition, the face panel can be substantially perpendicular to the shelf. The shelf is intended to support sheet goods at a convenient height for selection by a customer of the goods. In one embodiment, the display can further comprise of a support base that occupies the lower enclosure of the rectangular body, the support base having a plurality of substantially parallel first sheets transversely interconnected to at least one second sheet. The first and second sheets can have at least one slot where the slots of the first and second sheets interconnect. The interconnected first and second sheets provide supports for the shelf that is independent of the sidewall strength, which could be utilized to provide displays of superior performance with less material.

Thus, there is a need for a display system that allows sheet goods to be easily removed without lifting the sheet goods over an edge or lip. It is also desirable that the sheet goods be provided at a suitable elevation. Furthermore, there is a need for a display system that can ship separately as a kit in a minimum amount of space and that is lightweight and easy to assemble. Additionally, there is a need to utilize the structural strength of the sidewalls and other panel members to support the goods-supporting shelf while minimizing the amount of material used to form the display.

### SUMMARY OF THE INVENTION

A display can comprise a rectangular body, a shelf, and a header. The rectangular body can include a back panel, a face panel, and two upstanding side panels having a top edge. The top edge of the side panels can be inclined to face frontward toward the face panel. The shelf can partition the rectangular body into an upper display area and a lower enclosure. Furthermore, the header can extend upwardly from the back panel. The front panel can have a top edge that can be lower than the elevation of the shelf. In addition, the front panel can be substantially perpendicular to the shelf. The shelf is intended to support sheet goods at a convenient height for selection by a customer of the goods.

The display can further comprise of a support base that occupies the lower enclosure of the rectangular body. The support base can comprise of a plurality of substantially parallel first sheets transversely interconnected to at least one second sheet. The first and second sheets can have at least one slot where the slots of the first and second sheets interconnect.

The display can further comprise a frame. The frame can comprise a pair of side uprights and a platform. The side uprights can have at least one girder and can support the side panels. The platform can connect the girders and can support the side uprights and the shelf. Additionally, the display can comprise of at least one crosspiece that connects the side uprights. The crosspiece can support the side uprights and at least one of the front panel, the back panel, or the header, or any combination.

The display can comprise a rectangular body, and a pair of shelves separated by a header. The rectangular body can include a back panel, a pair of facing panels, and two upstanding side panels joining the facing panels to each other and to the back panel. A top edge of the side panels can be inclined to face away from the back panel and toward the facing panel. The shelves can partition the rectangular body into a pair of display areas and a lower enclosure. Furthermore, the header can extend upwardly from the back panel. The facing panels can have a top edge that can be lower than the elevation of the shelves. In addition, the facing panels can be substantially perpendicular to the shelves. The shelves are intended to support sheet goods on opposite sides of the header at a convenient height for selection by a customer of the goods

The display can also contain graphical indicia relating to the product. The graphical indicia can be found on one side or on both sides of the header, the back panel, the front panel, and the side panels. Furthermore, the display can further comprise of a product sample. The product sample can be placed on and removed from the upper display area.

The display can have a rectangular body including an upstanding back panel, an upstanding front panel, and two upstanding side panels, each of the panels forming the rectangular body including a plurality of slots. A shelf can partition the rectangular body into an upper display area and a lower enclosure. The shelf can include an edge parallel to each of the panels forming the rectangular body. Each edge of the shelf can include at least one tab received in one of the plurality of slots to support the shelf.

The slots in the panels of the display can be an upper horizontal slit and a lower horizontal slit, the slits defining a band of material between the slits, with the band being displaced inwardly into the interior of the display rectangular body. Each of the tabs on the shelf edges can have a length exceeding the distance between the upper and lower horizontal slits forming the slot in which the tab is received. The display can also have slots located in each of the lower corners of each of the panels. Foot members having a plurality upwardly extending tabs can engage at least one of the slots in the lower corners of each pair of the panels that are contiguous to support the display. A caster can be fixed to a downward facing surface of each of the foot members to facilitate movement of the display.

The display can be assembled by hinging two upstanding side panels to opposite vertical edges of an upstanding front panel so as to extend rearwardly from the front panel. The side panels can have inwardly folded rear edges. A foot member can be coupled to each of the lower corners that defined by a junction of the front panel with one of the side panels to fix the position of the side panels relative to the front panel. Tabs located along the edges of a shelf can be inserted into slots located in the upstanding front panel and the upstanding side panels to fix the position of the shelf. A pair of horizontal slits can be cut in the upstanding panels to define a band of material between the pair of slits. The band of material can them be displaced inwardly to form a slot for receiving a corresponding tab. A foot member can be coupled to each of the lower corners defined by a junction of the back panel with one of the side panels to fix the position of the side panels relative to the back panel. Caster assemblies can be provided on downward facing surfaces of the foot members to facilitate movement of the display. A graphics panel can be secured to an outside surface of at least one the upstanding panels with suitable indicia related to the product to be displayed.

Other features of the present invention and the corresponding advantages of those features will be come apparent from the following discussion of the preferred embodiments of the present invention, exemplifying the best mode of practicing the present invention, which is illustrated in the accompanying drawings. The components in the figures are not necessarily to scale, emphasis instead being placed upon illustrating the principles of the invention. Moreover, in the figures, like referenced numerals designate corresponding parts throughout the different views.

### BRIEF DESCRIPTION OF THE DRAWINGS

FIG. 1 is a perspective view of a display with a support base.

FIG. 2 is an exploded view of the support base in FIG. 1.

FIG. 3 is a perspective view of a display with a frame.

FIG. 4 is an exploded view of the display with a frame in FIG. 3.

FIG. 5 is a perspective view of another display.

FIG. 6 is a perspective view of yet another display.

FIG. 7 is an exploded view of the display shown in FIG. 6.

FIG. 8 is a perspective view of the bottom of the display shown in FIG. 6 only partially assembled.

FIG. 9 is a perspective detail of an inside front corner of the display shown in FIG. 6.

FIG. 10 is a perspective view of a bottom corner of a sidewall of the display shown in FIG. 6.

FIG. 11 is a perspective view of the display shown in FIG. 6 with the addition of graphics panels shown in exploded view.

### DESCRIPTION OF PREFERRED EMBODIMENTS

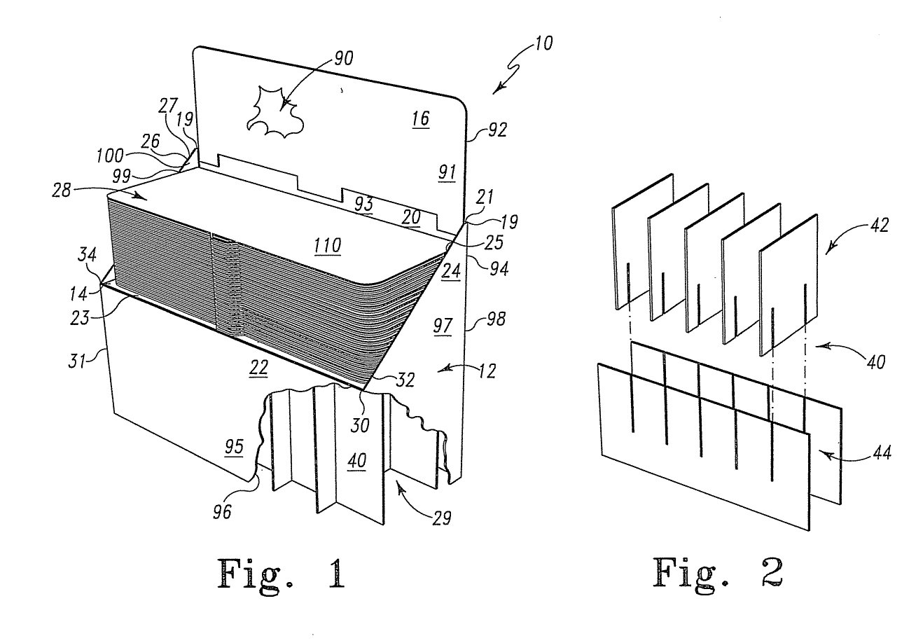

As shown in FIG. 1, a first display 10 has a rectangular body 12, a shelf 14, and a header 16. The rectangular body 12 includes a back panel 20, a face panel 22, and two upstanding side panels 24, 26 having top edges 25, 27, respectively. At least a portion of the top edges 25, 27 can be inclined to face frontward toward the face panel 22 so that a user has accessibility to the products 110, such as sheet goods, from the side if needed. The shelf 14 partitions the rectangular body 12 into an upper display area 28 and a lower enclosure 29. The shelf 14 is intended to support products 110 in the nature of sheet goods, such as floor mats, desk chair mats, or the like, at a convenient height for selection by a customer.

The header 16 extends upwardly from the back panel 20. The header 16 can be used for advertising the sheet goods on display. The back panel 20 has a top edge 21, and a highest point 19 of the top edges 25, 27 of the side panels 24, 26 can be at least as high as the top edge 21 of the back panel 20. The header 16 can extend upwardly from the top edge 21 of the back panel. In addition, the header 16 and the back panel 20 can be co-planar. In some embodiments, the header 16 and the back panel 20 are one piece. The header 16 and the back panel 20 can be separated by a fold-line.

The face panel 22 has a top edge 23. The top edge 23 can be lower than the elevation of the shelf 14. The face panel 22 is also substantially perpendicular to the shelf 14. The side panels 24, 26 have a front edge 30, 31, respectively. The front edges 30, 31 meet the top edges 25, 27 of the side panels to form vertices 32, 34 respectively. The vertices 32, 34 can be at least as high as the top edge 23 of the face panel.

The display 10 can further include a support base 40 that occupies the lower enclosure 29 of the rectangular body as shown in FIG. 1. As shown in FIG. 2, the support base 40 can be formed by a plurality of substantially parallel first sheets 42 transversely interconnected to at least one second sheet 44. Each of the first sheets 42 and second sheet or sheets 44 can have at least one slot 46, where the slot or slots of the first sheet 42 interconnect with slot or slots of the second sheet 44. The support base 40 should be sufficiently strong to resist the load of the shelf 14, the display 10, and sheet goods, yet sufficiently light weight to avoid contributing significantly to the overall load. Thus, the support base 40 and the first display unit 10 should be made of any lightweight, sturdy material known in the art. For example, various combinations of corrugated board, fiberboard, paper, plastic or metal can be used.

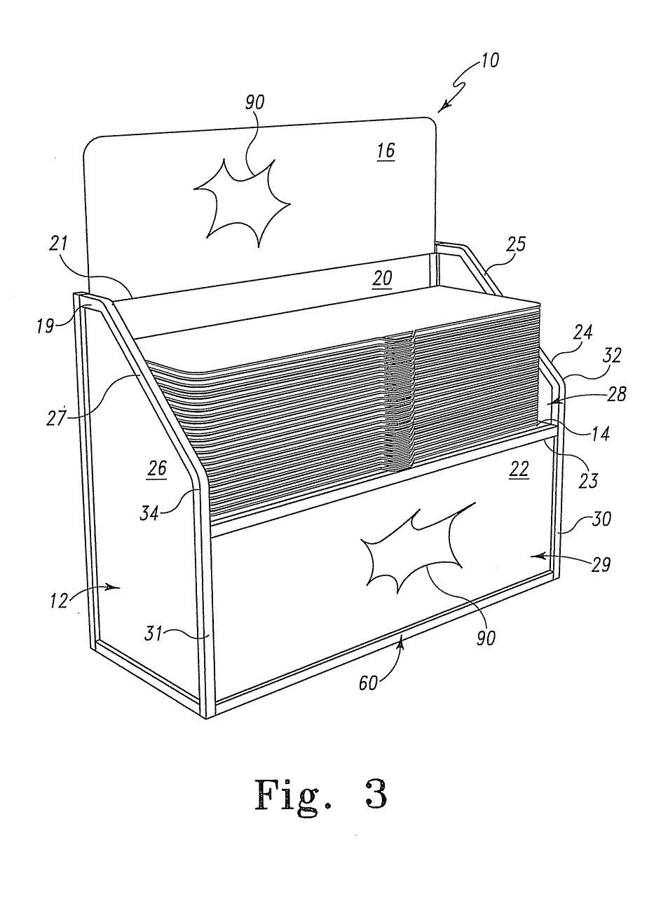

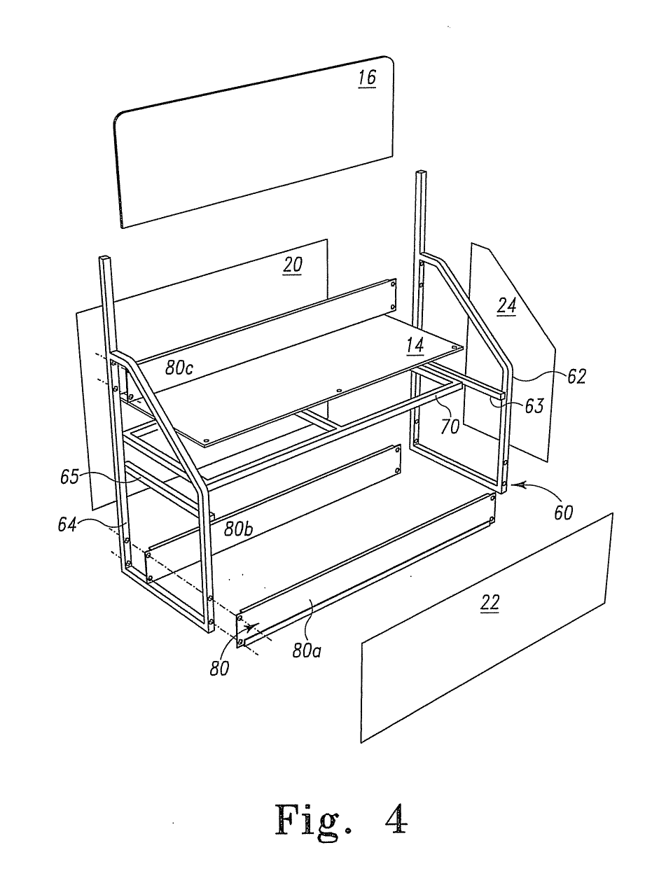

A second display 10 is shown in FIGS. 3 and 4 to have a rectangular body 12, a shelf 14, and a header 16. The rectangular body 12 includes a back panel 20, a face panel 22, and two upstanding side panels 24, 26 having top edges 25, 27, respectively. At least a portion of the top edges 25, 27 can be inclined to face frontward toward the face panel 22. The shelf 14 partitions the rectangular body 12 into an upper display area 28 and a lower enclosure 29. The shelf 14 can be made of any light weight material that sufficiently supports the load of sheet goods, such as particle board, corrugated board, fiberboard, plastic or metal.

As in the first display, the header 16 extends upwardly from the back panel 20. The back panel 20 has a top edge 21, and a highest point 19 of the top edges 25, 27 of the side panels 24, 26 can be at least as high as the top edge 21 of the back panel 20. The header 16 can extend upwardly from the top edge 21 of the back panel. In addition, the header 16 and the back panel 20 can be co-planar. The face panel 22 has a top edge 23 that is substantially perpendicular to the shelf 14 and the top edge 23 is lower than the elevation of the shelf 14. The side panels 24, 26 have a front edge 30, 31, respectively. The front edges 30, 31 meet the top edges 25, 27 of the side panels to form vertices 32, 34, respectively. The vertices 32, 34 can be at least as high as the top edge 23 of the face panel.

The second sample display unit 10 can further include a frame 60 as shown in FIG. 4. The frame 60 can include a pair of side uprights 62, 64 and a platform 70. Each of the side uprights 62, 64 can have at least one girder 63, 65, respectively. The girders 63, 65 primarily support the platform 70. Furthermore, the side uprights 62, 64 can support the side panels 24, 26, respectively. The platform 70 can connect the girders 63, 65 and can support the side uprights 62, 64 and the shelf 14. Additionally, the sample display unit 10 can have at least one crosspiece 80 that connects the side uprights 62, 64. (Three crosspieces 80a, 80b, 80c are shown in FIG. 4). The crosspiece 80 can support the side uprights 62, 64 and at least one of the face panel 22, the back panel 20, or the header 16, or any combination thereof. The frame 60 can be made of various materials known in the art to be rigid and light, such as metal, plastic, wood, etc. In accordance with FIGS. 3 and 4, the frame consists of metal tubing.

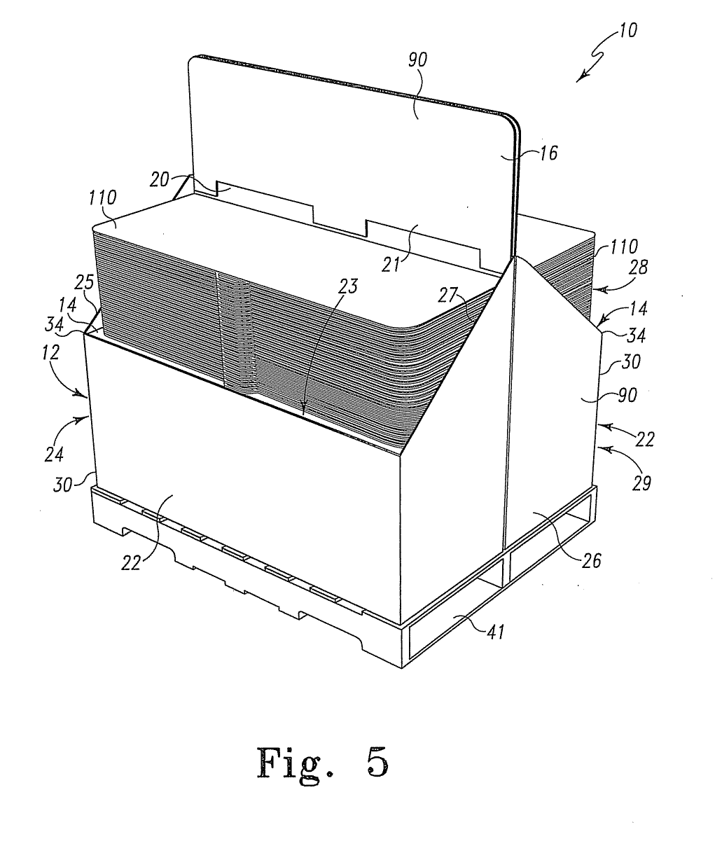

A third display 10 is shown in FIG. 5 to include a rectangular body 12, a pair of shelves 14 separated by a header 16. The rectangular body 12 includes a back panel 20, a pair of face panels 22, and two upstanding side panels 24, 26 having top edges 25, 27, respectively. At least a portion of the top edges 25, 27 can be inclined toward the adjacent face panel 22 so that a user has accessibility to the sheet goods from either side, if needed. The shelves 14 partition the rectangular body 12 into an upper display area 28 and a lower enclosure 29. The shelves 14 are intended to support products 110 in the nature of sheet goods, such as floor mats, desk chair mats, or the like, at a convenient height for selection by a customer of the goods.

The header 16 extends upwardly from the back panel 20. The header 16 can be used for advertising the sheet goods on display. The back panel 20 has a top edge 21, and a highest point 19 of the top edges 25, 27 of the side panels 24, 26 can be at least as high as the top edge 21 of the back panel 20. The header 16 can extend upwardly from the top edge 21 of the back panel. In addition, the header 16 and the back panel 20 can be co-planar. The header 16 and the back panel 20 can be formed of one piece, and the header 16 and the back panel 20 can be separated from each other by a fold-line coincident with top edge 21.

The face panels 22 have a top edge 23. The top edges 23 can be parallel to each other and at the same elevation as the shelf 14. The face panels 22 can also be substantially perpendicular to the shelf 14. The side panels 24, 26 have edges 30, 31, respectively. The edges 30, 31 meet the top edges 25, 27 of the side panels to form vertices 32, 34, respectively. The vertices 32, 34 can be at least as high as the top edge 23 of the face panels 22. Like the first display shown in FIGS. 1 and 2, the display 10 of FIG. 5 can include a support base 40 that occupies the lower enclosure 29 of the rectangular body as shown in FIG. 2. The support base 40 can comprise of a plurality of substantially parallel first sheets 42 transversely interconnected to at least one second sheet 44 as shown in FIG. 2. Alternatively, the third display 10 can be formed with frame as shown in FIG. 4. The support base 40 having either construction can be conveniently supported on a standard pallet 41 if the sheet goods 110 are of a suitable size. Additionally, a pair of the display units 10 shown in FIGS. 1-4 can also be conveniently supported on a standard pallet 41 in like manner.

The sample display units 10 can also contain graphical indicia 90 relating to the products 110. According to FIG. 1, the graphical indicia 90 can be found on one side or on both sides 91, 92 of the header 16, both sides 93, 94 of the back panel 20, both sides 95, 96 of the face panel 22, and both sides 97, 98 and 99, 100 of the side panels 24, 26, respectively. Furthermore, with the first and second displays 10, the products 110, such as floor mats, desk chair mats, etc., can be placed on the shelf 14, and removed from the upper display area 28 without encountering any obstruction along the top edge 23. Additionally, the products 110 can be available at a suitable elevation, namely the shelf can be at a height between about 18-30 inches to facilitate customer selection.

The vertices 32, 34 are shown in FIG. 3 to be higher than the top edge 23 of the face panel. However, in FIG. 1, the vertices 32, 34 to be substantially the same height as the top edge 23 of the face panel as shown in FIG. 1. Moreover, the top edges 25, 27 shown in FIG. 1 are entirely inclined, while the top edges 25, 27 in FIGS. 3 and 4 are partially inclined. Also shown in FIGS. 1, 2, and 4, the top edges 25, 27 of the side panels 24, 26 are substantially the same height as the top edge 21 of the back panel 20. The embodiments in FIGS. 1, 2, and 4 also show the header 16 extending upwardly from the top edge 21 of the back panel 20 and the header 16 as coplanar with the back panel 20. Additionally shown in FIG. 4, the header 16 can also be supported by the side uprights 62, 64

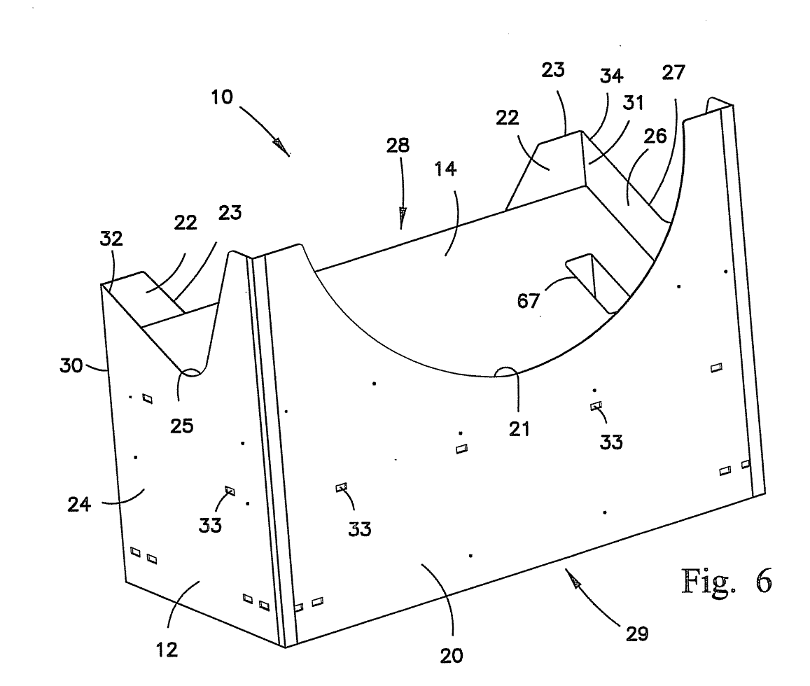

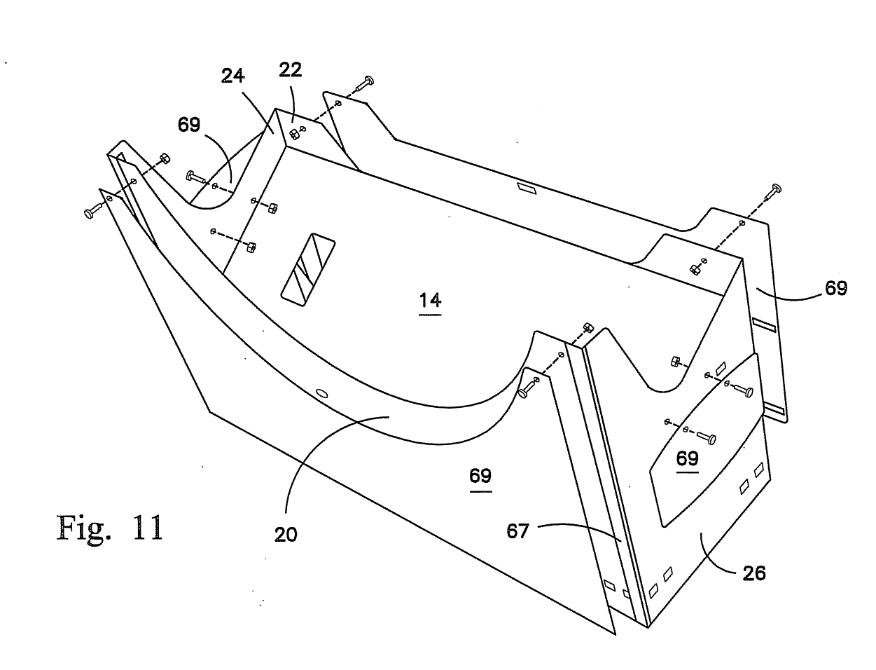

FIGS. 6-11 show a fourth display 10 that can be formed of sheet materials, such as steel or other metal. The fourth display 10 includes a rectangular body 12, and a shelf 14. The rectangular body 12 includes a back panel 20, a face panel 22, and two upstanding side panels 24, 26 having top edges 25, 27, respectively. At least a portion of the top edges 25, 27 can be inclined to face frontward toward the face panel 22. The shelf 14 partitions the rectangular body 12 into an upper display area 28 and a lower enclosure 29. The shelf 14 is intended to support products in the nature of sheet goods, such as floor mats, desk chair mats, or the like, at a convenient height for selection by a customer. The shelf 14 is shown to be inclined, but could also be positioned horizontally. Likewise, the shelf 14 of the displays shown in FIGS. 1-5 could be inclined.

The back panel 20 has a top edge 21, and a highest point 19 of the top edges 25, 27 of the side panels 24, 26 can be at least as high as the top edge 21 of the back panel 20. The face panel 22 has a top edge 23. The top edge 23 can be lower than the elevation of the shelf 14. The face panel 22 can be substantially perpendicular to the shelf 14. The side panels 24, 26 have a front edge 30, 31, respectively. The front edges 30, 31 meet the top edges 25, 27 of the side panels to form vertices 32, 34 respectively. The vertices 32, 34 can be at least as high as the top edge 23 of the face panel.

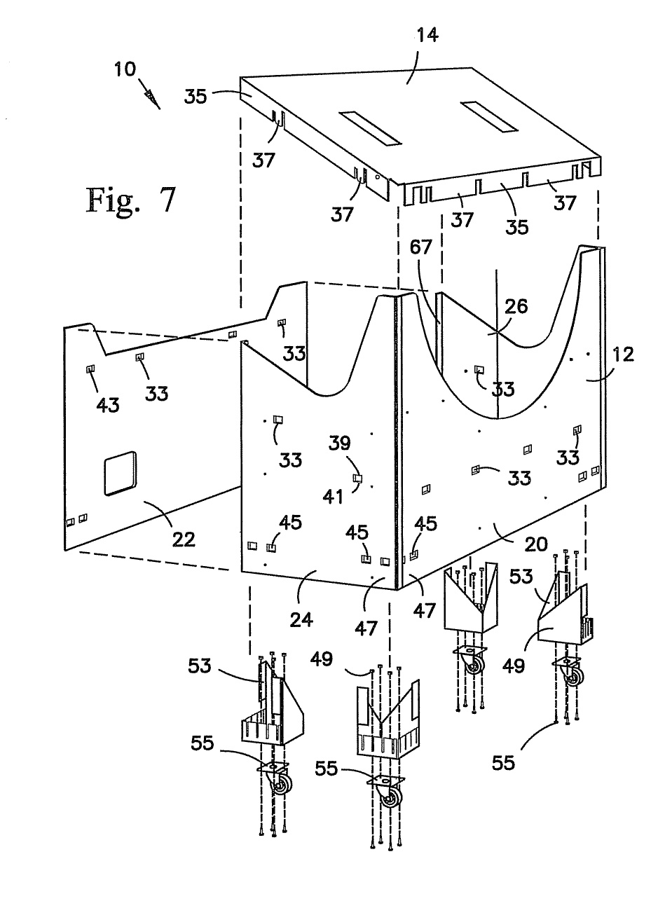

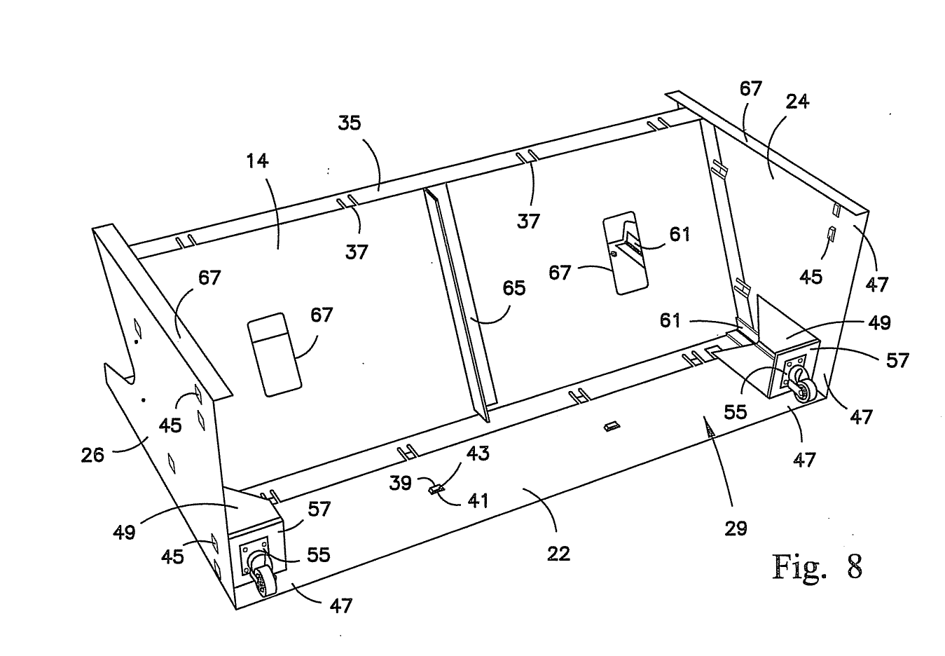

Each of the panels 20, 22, 24, 26 forming the rectangular body 12 includes a plurality of slots 33. The shelf 14 includes a downwardly extending edge 35 parallel to each of the panels 20, 22, 24, 26 forming the rectangular body 12 as seen in FIGS. 7 and 8. Each edge 35 including at least one tab 37 that can be received in one of the plurality of slots 33 so that the shelf 14 is supported by the four panels 20, 22, 24, 26. Each of the slots 33 can be formed by a pair of slits 39, 41 that are separated from each other by an intervening band 43 of material. The band 43 can be displaced inwardly into the interior of the rectangular body 12 as shown in FIG. 10. While the material forming the band 43 is shown to be integral with the material forming the four panels 20, 22, 24, 26, the band 43 could be a separately formed structure that is fixed to the panels at the desired location. Each of the tabs 37 on the shelf edges 35 can have a length exceeding the distance between the upper and lower horizontal slits 39, 41 forming the slot 33 in which the tab 37 is received. At least one bracing member 65 can be provided on the bottom surface of the shelf 14 for added support as seen in FIG. 8. Openings 67 can be provided in the shelf 14 to provide access to the lower enclosure 29 while the display 10 is in an upright position.

A pair of slots 45, having a structure similar to slots 33, can be located in lower corners 47 of each of the panels 20, 22, 24, 26 forming the rectangular body 12. A foot member 49, shown in FIGS. 7 and 8, having a plurality upwardly extending tabs 51, similar in construction to tabs 37, can engage at least one of the pair of slots 45 in the lower corners 47 of two of the panels 20, 22, 24, 26 that are contiguous. The foot members 49 can include integral bracing elements 53 designed to abut the inner surface of the panels to which foot members 49 are coupled. Caster assemblies 55 can be fixed to downward facing surfaces 57 of the foot members 49 facilitate movement of the display 10.

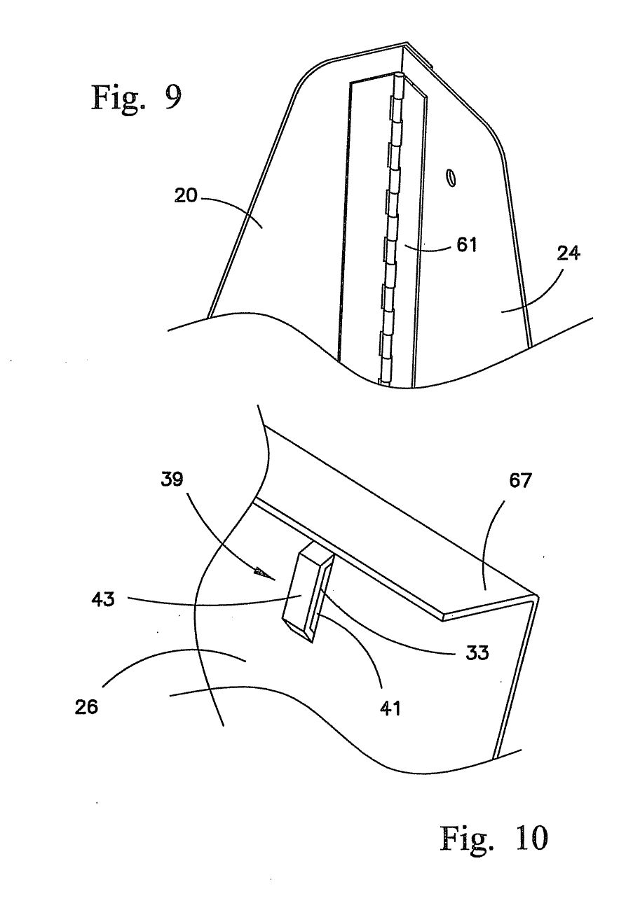

The fourth display 10 has coupling means 59 coupling adjacent vertical lateral edges of the upstanding panels 20, 22, 24, 26 forming the rectangular body 12. The coupling means 59 can take the form of a hinge 61, shown in detail in FIG. 9, pivotally connecting a vertical lateral edge of each of the upstanding side panels 24, 26 to one of the upstanding face panel 22 and back panel 20. The coupling means 57 can also take the form of an inwardly folded edge 67, shown in detail in FIG. 10, overlapping the contiguous vertical lateral edges of the other of the upstanding face panel 22 and back panel 20. The display 10 can also contain graphical indicia relating to the product to be displayed. The graphical indicia can be found on separate advertising panels 69 that can be coupled to the back panel 20, the face panel 22, and the side panels 24, 26.

The display 10 can be shipped separately from the sheet goods 110. If this is the case, the display 10 can be shipped as components forming a kit. When the sample display unit kit arrives at a destination, the kit can be located near where the display will be used. If the sample display unit 10 is similar to the first embodiment, then the sample display unit would be shipped in a few components including the support base 40. The rectangular box 12 would then be assembled, as well as the support base 40. The shelf 14 and header 16 would then be placed at their respective locations. Next, the rectangular box 12 would be placed on top of the support base 40. Minor movement may be needed to position all the pieces in the correct fashion. Lastly, the sheet goods 110 are stacked on top of the shelf 14, and the sample display unit 10 is ready for use.

If, however, the sample display unit 10 is similar to the second embodiment, then the sample display unit 10 can be shipped as several components in a kit as shown in FIG. 4. When the sample display unit kit arrives at a destination, the kit can be located near where the display will be used. First, the side uprights 62, 64 including the girders 63, 65 are placed upright and are oriented in a way that the girders face the inside. Next, the platform 70 is attached to the girders 63, 65 in between the side uprights 62, 64. The shelf 14 is then attached to the platform 70. The crosspieces 80 are then attached to the side uprights 62, 64. Subsequently, the side panels 24, 26, the face panel 22, the back panel 20, and header 16 can be attached to the side uprights 62, 64 and crosspieces 80. Once setup, the sample sheet goods 110 can be placed on top of the shelf 14 and the sample display unit 10 is ready for use.

If, however, the sample display unit 10 is similar to the fourth embodiment, then the sample display unit 10 can be shipped as several components in a kit as shown in FIG. 7. When the sample display unit kit arrives at a destination, the kit can be located near where the display will be used. First, the upstanding side panels 24, 26, which are coupled by hinges 61 to opposite vertical edges of the upstanding face panel 22 are pivoted so as to extend rearwardly from the face panel 22. Next, a foot member 49 can be coupled to each of the lower corners 47 defined by the junction of the face panel 22 with one of the side panels 24, 26 to fix the position of the side panels 24, 26 relative to the face panel 22. Next, the tabs 37 located along the edges 35 of the shelf 14 can be inserted into slots 33 located in the face panel 22 and the side panels 24, 26 to fix the position of the shelf 14. Next, the back panel 20 is inserted between the shelf 14 and the inwardly folded rear edges 67 of the side panels 24, 26, and into engagement with the tabs 37 located along the edges 35 of the shelf 14. A foot member 49 can then be coupled to each of the lower corners 47 defined by the junction of the back panel 20 with one of the side panels 24, 26 to fix the position of the back panel 20 relative to the side panels 24, 26. Once setup, advertising panels 69 can be coupled to at least one of the face panel 22, side panels 24, 26 and back panel 20. The sheet goods 110 can be placed on top of the shelf 14 and the display 10 is ready for use.

Thus, after setup, the sample display unit 10 allows sheet goods to be easily removed. A user can easily slide the sheet goods 110 from the stack without having to lift the sheet goods 110 over an edge or lip. This is accomplished by having the top edge 23 of the face panel 22 located below the elevation of the shelf 14. Also, the user can access the sheet goods 110 from the sides because of the inclined top edges 25, 27 of the side panels 24, 26. Furthermore, the user is provided the sheet goods at a suitable elevation. This is accomplished by designing the shelf 14 to be at a certain distance from the floor in order to alleviate the need to bend at the back or waist. Because the sample display unit 10 can be separated into components, a user could easily ship the sample display unit 10 as a kit and assemble on site.

While these features have been disclosed in connection with the illustrated preferred embodiments, other embodiments of the invention will be apparent to those skilled in the art that come within the spirit of the invention as defined in the following claims.

What is claimed is:

1. A display comprising: a rectangular body including an upstanding back panel, an upstanding front panel, and two upstanding side panels, each of the panels forming the rectangular body including a plurality of slots; a shelf partitioning the rectangular body into an upper display area and a lower enclosure, the shelf including an edge parallel to each of the panels forming the rectangular body, each edge including at least one tab received in one of the plurality of slots to support the shelf.

2. The display of claim 1, wherein each slot in the panels forming the rectangular body comprises an upper horizontal slit and a lower horizontal slit, the slits defining a band of material between the slits, the band being displaced inwardly into the interior of the rectangular body.

3. The display of claim 2, wherein each of the tabs on the shelf edges has a length exceeding the distance between the upper and lower horizontal slits forming the slot in which the tab is received.

4. The display of claim 1, further comprising a pair of slots located in lower corners of each of the panels forming the rectangular body, and foot members having a plurality upwardly extending tabs engaging at least one of the pair of slots in the lower corners of two of the panels that are contiguous.

5. The display of claim 4, further comprising a caster fixed to a downward facing surface of each of the foot members.

6. The display of claim 1, further comprising hinges connecting each of the upstanding side panels to at least one of the upstanding front and back panels.

7. The display of claim 6, wherein only one of the upstanding front and back panels is connected by hinges to the upstanding side panels, the upstanding side panels having inwardly folded edges overlapping contiguous edges of the other of the upstanding front and back panels.

8. The display of claim 1, wherein each of the panels forming the rectangular body include a lowermost edge defining a lower boundary of the lower enclosure, the shelf being situated at an angle with respect thereto.

9. A display comprising: a rectangular body including an upstanding back panel, an upstanding front panel, and two upstanding side panels, each of the upstanding panels having vertical lateral edges, each of the panels forming the rectangular body including a plurality of slots, each slot in the panels forming the rectangular body including an upper horizontal slit and a lower horizontal slit, the slits defining a band of material between the slits, the band being displaced inwardly into the interior of the rectangular body; a shelf partitioning the rectangular body into an upper display area and a lower enclosure, the shelf including an edge parallel to each of the panels forming the rectangular body, each edge including at least one tab received in one of the plurality of slots to support the shelf, each of the tabs on the shelf edges having a length exceeding the distance between the upper and lower horizontal slits forming the slot in which the tab is received.

10. The display of claim 9, further comprising coupling means coupling adjacent vertical lateral edges of the upstanding panels.

11. The display of claim 10, wherein the coupling means comprises a hinge pivotally connecting a vertical lateral edge of each of the upstanding side panels to one of the upstanding front and back panels.

12. The display of claim 11, wherein the upstanding side panels further comprise inwardly folded edges overlapping contiguous edges of the other of the upstanding front and back panels.

13. The display of claim 9, further comprising a graphics panel attached to an outside surface of one the upstanding panels forming the rectangular body.

14. The display of claim 9, wherein each of the panels forming the rectangular body include a lowermost edge defining a lower boundary of the lower enclosure, the lowermost edge of all of the panels lying in a single plane, the shelf being situated at an angle with respect to the plane.

15. The display of claim 14, further comprising a pair of slots located in lower corners of each of the panels forming the rectangular body, and foot members having a plurality upwardly extending tabs engaging at least one of the pair of slots in the lower corners of two of the panels that are contiguous, all of the foot members having a downward facing surface positioned at a uniform distance from said single plane.

16. The display of claim 15, further comprising a caster fixed to the downward facing surface of each of the foot members.

17. A method of assembling a display comprising:
hinging upstanding side panels to opposite vertical edges of an upstanding front panel so as to extend rearwardly from the front panel, the side panels having inwardly folded rear edges;
coupling a foot member to each of the lower corners defined by a junction of the front panel with one of the side panels to fix the position of the side panels relative to the front panel;
sliding tabs located along edges of a shelf into slots located in the upstanding front panel and the upstanding side panels to fix the position of the shelf;
sliding a back panel between the shelf and the inwardly folded rear edges of the side panels into engagement with the shelf; and
coupling a foot member to each of the lower corners defined by a junction of the back panel with one of the side panels to fix the position of the side panels relative to the back panel.

18. The method of claim 17, further comprising:
providing caster assemblies on downward facing surfaces of each of the foot members.

19. The method of claim 17, further comprising:
attaching a graphics panel to an outside surface of at least one the upstanding panels.

20. The method of claim 17, further comprising defining each of said slots by cutting a pair of horizontal slits in one of the upstanding panels to define a band of material between the pair of slits, and displacing the band of material inwardly.
